(19) United States
(12) Patent Application Publication
(10) Pub. No.: US 2024/0303692 A1
(43) Pub. Date: Sep. 12, 2024

(54) System And Method For Personalized Banner Placement

(71) Applicant: Google LLC, Mountain View, CA (US)

(72) Inventor: Dongeek Shin, San Jose, CA (US)

(21) Appl. No.: 18/280,740

(22) PCT Filed: Sep. 20, 2022
(86) PCT No.: PCT/US2022/044100

§ 371 Date: Sep. 7, 2023

(51) Int. Cl. G06Q 30/0251; G06F 40/106; G06Q 30/0241

(52) U.S. Cl. CPC G06Q 30/0255; G06F 40/106; G06Q 30/0276; G06Q 30/0277

(57) ABSTRACT

The present disclosure provides for determining personalized banner placement in relation to content based on probabilistic spatial user engagement. The probabilistic spatial user engagement can be determined based on user input signals, types of content, or a combination of user input signals and types of content. Such determination may be used to identify regions of a page displaying the content where banners may be rendered for maximum user engagement and minimal disruption of the content.

### BACKGROUND

Ad placement in web pages is often limited to a discrete number of possible placement options. Placement of an ad can impact visibility of the ad, as well as interference with content on the web page. The degree of visibility can have a correlation with the degree of interference. For example, for a web page containing an article, an ad placed in the middle of the article can have high visibility and a high likelihood of catching a reader's attention, but it can also have a high degree of interference as it would likely disrupt the reader's ability to continuously read the article, thereby causing irritation to the reader. Optimal ad placement can maximize visibility while minimizing interference. To find such optimal placement, different ad placement options can be tested through research and surveys, but this can be costly and time consuming to gather user feedback.

### BRIEF SUMMARY

The present disclosure provides for personalization of ad placement. The personalized ad placement for a given user can be based on spatial engagement by the user with different portions of a web page. For example, a spatial probability map may be generated for the given user based on the given user's likelihood of engaging with various portions of the web page. The likelihood of engaging can be determined using input signals from the given user, such as gaze, scrolling speed, pauses in scrolling, zooming, panning, or any of a variety of other inputs. According to some examples, the personalized ad placement can be further based on the format of content or subject matter of content being displayed on the web page. For example, for the given user, different spatial probability maps may be generated for articles than for listings. In another example, for the given user, different spatial probability maps may be generated for articles about sports as compared to articles about politics.

One aspect of the disclosure provides a method of determining banner placement, comprising determining, with one or more processors, a probability of user engagement with respect to various portions of a page of content, generating, with the one or more processors, a spatial probability map based on the determined probability, the spatial probability map indicating user engagement probability with respect to the various portions of the page of content, identifying, with the one or more processors, one or more constraints for banner placement for the page of content, determining, based on the spatial probability map in combination with the one or more constraints, placement for at least one banner, and transmitting, by the one or more processors, the at least one banner to a user device for rendering in the determined placement.

Determining the probability of user engagement may include detecting user input signals in relation to the page of content. The user input signals may include at least one of frequency or speed of scrolling. The user input signals may further include information related to visibility of the page with respect to other browser tabs.

Determining the probability of user engagement may include identifying a topic of the content, determining, with the one or more processors, a user preference weight for the topic of the content, and determining the probability of user engagement based on the user preference weight for the topic of the content. Identifying the topic of the content may be based on identification of keywords. Determining the user preference weight for the topic of content may be based on historical user interaction with the topic of the content among a variety of other topics of content. In other examples, determining the user preference weight for the topic of content may be based on historical user interaction with the topic of the content from a plurality of users.

The method may further include receiving digital content and the at least one banner at the user device, and rendering the digital content with the at least one banner in the determined placement for the banner. According to some examples, the method may include preventing rendering of at least one second banner in at least one second banner location in the page of content.

In some examples, one or more constraints may include options for banner placement based on a degree of interference with the content. Determining placement for the banner may include determining, with the one or more processors, a degree of overlap between the spatial probability map and the options for banner placement, and identifying, with the one or more processors, portions of the page having a highest degree of overlap.

Another aspect of the disclosure provides a system for determining banner placement, comprising memory and one or more processors in communication with the memory. The one or more processors may be configured to determine a probability of user engagement with respect to various portions of a page of content, generate a spatial probability map based on the determined probability, the spatial probability map indicating user engagement probability with respect to the various portions of the page of content, identify one or more constraints for banner placement for the page of content, determine, based on the spatial probability map in combination with the one or more constraints, placement for at least one banner, and transmit the at least one banner to a user device for rendering in the determined placement.

In determining the probability of user engagement, the one or more processors may be further configured to detect user input signals in relation to the page of content. The user input signals may include at least one of frequency or speed of scrolling. In some examples the user input may further include information related to visibility of the page with respect to other browser tabs.

In determining the probability of user engagement, the one or more processors may be further configured to identify a topic of the content, determine a user preference weight for the topic of the content, and determine the probability of user engagement based on the user preference weight for the topic of the content. Identifying the topic of the content may be based on identification of keywords. The user preference weight for the topic of content may be based on historical user interaction with the topic of the content among a variety of other topics of content and/or historical user interaction with the topic of the content from a plurality of users.

The one or more processors may be further configured to transmit digital content and at least one banner to a client device for rendering the digital content along with the at least one banner in the determined placement for the banner. They may further prevent rendering at least one second banner in at least one second banner location in the page of content.

The one or more constraints may include options for banner placement based on a degree of interference with the content. In determining placement for the banner, the one or more processors may be further configured to determine a degree of overlap between the spatial probability map and the options for banner placement, and identify portions of the page having a highest degree of overlap.

Yet another aspect of the disclosure provides a non-transitory computer-readable medium storing instructions executable by one or more processors for performing a method of determining banner placement, comprising determining a probability of user engagement with respect to various portions of a page of content, generating a spatial probability map based on the determined probability, the spatial probability map indicating user engagement probability with respect to the various portions of the, of content, identifying one or more constraints for banner placement for the page of content, determining, based on the spatial probability map in combination with the one or more constraints, placement for at least one banner, and transmitting the at least one banner to a user device for rendering in the determined placement.

### BRIEF DESCRIPTION OF THE DRAWINGS

FIG. 1 illustrates an example spatial probability map indicating a probability of user engagement with a web page according to aspects of the disclosure.

FIG. 2 is another example spatial probability map indicating a probability of user engagement with a web page according to aspects of the disclosure.

FIG. 3 illustrates an example of multiple spatial probability maps generated for a given user based on different content formats according to aspects of the disclosure.

FIG. 4 illustrates an example of combining a spatial probability map with web page constraints related to banner placement according to aspects of the disclosure.

FIG. 5 is a block diagram illustrating an example system according to aspects of the disclosure.

FIG. 6 is a flow diagram illustrating an example method according to aspects of the disclosure.

### DETAILED DESCRIPTION

The present disclosure provides for determining personalized banner placement in relation to content based on probabilistic spatial user engagement. The probabilistic spatial user engagement can be determined based on user input signals, types of content, or a combination of user input signals and types of content. Such determination may be used to identify regions of a page displaying the content where banners, such as ads, may be displayed to optimize user engagement while minimizing disruption of the content.

In the example of determining probabilistic spatial user engagement based on user input signals, the user input signals are received in connection with content viewed by the user. The user input signals are used to determine spaces, in relation to the content, where the user focuses while viewing the content.

The user input can include, for example, frequency of scrolling. For example, it may be determined how long the user dwells on a portion of the content before scrolling to another portion. Supplemental signals may be additionally considered to determine whether the user is actively looking at the content during the time the user input signals are received. Such supplemental signals may include factors such as a number of browser tabs open, whether the content is on a main browser tab, etc.

A spatial probability map may be generated based on the determining. The spatial probability map may be, for example, a 2D array of pixels, where higher pixel levels correspond to higher engagement and lower pixels correspond to lower engagement.

In the example of determining probabilistic spatial user engagement based on type of content, the type of content may relate to a topic or subject matter of the content and a language-vision model may be used to identify portions of the web page where such topic is most prevalent. For example, user preferences may be determined based on explicit or implicit signals, such as express user input, user browsing history, content subscriptions, etc. If the user preferences include web content relating to a particular topic, the web content topic can be weighed in the probability map to represent a higher level of engagement.

According to some examples, a joint probability distribution may be used to combine probabilities based on user input with probabilities based on content topic.

According to some examples, the probability map may be combined with a set of constraints, such as known banner placement options. A banner may be, for example, an advertisement, notification, or other content or information. Banners may vary in size, shape, orientation, position, etc. The constraints, by way of example, may restrict banner placement options to a top portion of a page, a bottom portion of a page, or a side portion of a page. Combining the probability map with the constraints may identify portions where there is overlap, indicating a region of the page with high engagement probability coincides with a region in which banner placement is permitted. A degree of overlap can be used to rank placement options, such that higher priority banners are placed in regions with a highest degree of overlap.

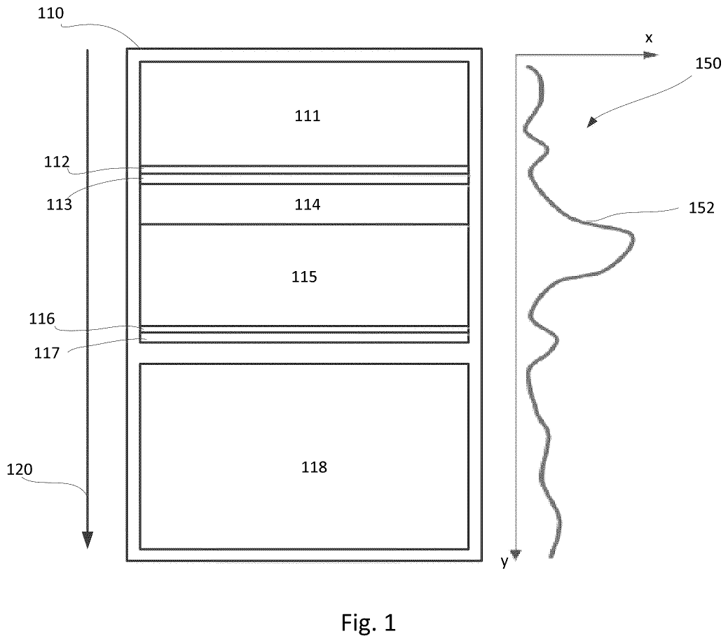

FIG. 1 illustrates an example of a spatial probability map 150 corresponding to a page 110 of content. The content may have any of a variety of formats that can be displayed via a web page, such as articles, listings, social media pages, chat forums, media streaming, or any other format including one or more of text, images, video, audio, etc. The content may also be of any of a variety of types, such that it may describe or otherwise relate to any of a variety of topics, such as sports, news, shopping, etc.

The page 110 includes a number of visualized web regions 111-118. Each region may be established based on how content is laid out on the page. For example, the regions can be determined by reading through an html source that defines text/image zones using hard rules. As another example, the regions can be determined by running a language/vision model over the webpage content to automatically interpret regions. The web regions 111-118 may each have a same or different size relative to one another. Collectively, the web regions 111-118 may cover substantially the entire web page. While the entire web page 110 is shown in FIG. 1, only a portion of the web page 110 may fit within a viewing field of a user display device at a given time, thereby making only a subset of the web regions 111-118 visible in the viewing field of the display device at the given time. Arrow 120 indicates a direction of scrolling of the web page. While the arrow 120 indicates scrolling in a vertical direction, in some examples the scrolling may alternatively or additional be performed in a lateral direction.

The spatial probability map 150 indicates a probability, relative to each web region 111-118, of user engagement. For example, the probability may indicate a likelihood that a particular user will focus on each given region. In this example, the further curve 152 extends in an x direction may correspond to an increased probability of user engagement.

The probability of user engagement may be determined based on one or more inputs. One example input includes a frequency of scrolling. For example, a user's dwell time on a region before scrolling further down a page to a next region may be used to determine a probability of engagement. A relationship between dwell time and engagement may be non-linear, because the user may be distracted by something irrelevant to the web page, such as if the user stopped scrolling to have a conversation with a person that entered a same room as the user. Other example inputs include eye gaze, zooming in or out, audio, etc. For example, eye gaze detection may detect which web regions are within a focus of the user's gaze and a duration of gaze upon each region. Web regions 111-118 in which a user zoomed in may indicate a greater probability of engagement, as it suggests the user was interested in seeing something within the region in more detail. Audio may be used to capture verbal expressions in response to content on the web page. For example, expressions such as “Wow” or “no way” may be correlated with web regions being viewed at a time the audio was received. The user may be provided with controls allowing the user to make an election as to both if and when systems, programs, or features described herein may enable collection of the user input.

Examples of such supplemental input signals include a number of web browsers open, a number of tabs open in each browser, whether the web page is an active or main browser tab, etc. Where multiple input signals are used to determine the probability, each input signal may be weighted the same or differently. For example, eye gaze may be weighted greater than scrolling speed, etc.

The input may be converted into the spatial probability map using, for example, a regression model. For example, the probability of user engagement can be computed using a linear regression formula summing up each feature probability determined by a heuristic, such as P(engagement)=w_scrolling*P(scrolling)+w_click*P(click) . . . , where P represents a probability and w represents a weight for the probability.

The spatial probability map 150 shown in this example is a one-dimensional spatial engagement probability based upon scrolling the web page in a second dimension. For example, a y axis of the map 150 corresponds to the direction of scrolling of the web page 110, while the x axis of the map 150 corresponds to a probability of user engagement for a corresponding portion of the web page 110.

In other examples, the spatial probability map 150 may be created in multiple dimensions, such as two, three, or more dimensions. For example, it should be understood that the spatial probability map 150 may take any of a variety of forms, such as graphical or other forms.

While the example of FIG. 1 describes the spatial probability map in connection with a web page, the spatial probability map may similarly be generated for other mediums through which content is provided, such as mobile applications, etc.

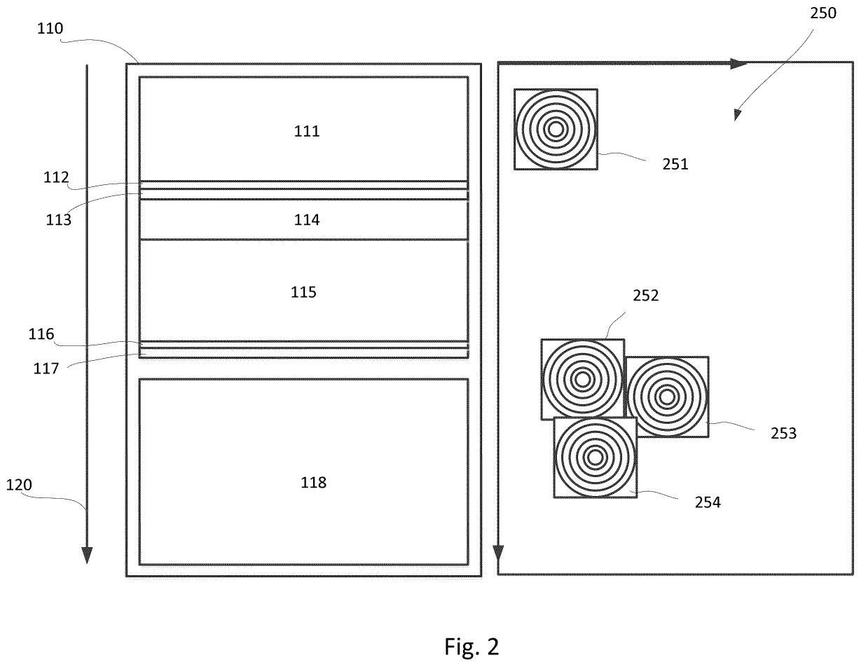

FIG. 2 illustrates an example of another type of spatial probability map 250. The spatial probability map 250 may be estimated using information in the content on the web page 110. For example, if the user likes visiting web sections related to particular topics, the presence of such topics in web regions 111-118 of the web page 110 may be used to determine a probability of engagement for each region 111-118. In the example of FIG. 2, indicators 251-254 are used to identify portions of the web page 110 where the user is most likely to focus based on the presence of content in such regions that corresponds to the topics the user likes.

Determination of topics that the user likes may be made based on implicit or explicit signals from the user. For example, implicit signals may include browsing history, such as websites visited and the type of information included in such sites. For example, if the user frequently visits web pages with information relevant to sports, travel, or news, the topics of sports, travel, and news may be identified as topics of potential interest for the user. Other examples of implicit signals may include subscriptions, transactions, apps downloaded, search queries, etc.

Explicit signals may include, for example, direct user input such as through a user interface. For example, the user may answer one or more questions, or otherwise enter information indicating which topics the user likes. According to one example, the user preferences may be stored as part of a user profile, or in any other way.

According to some examples, different topics may be weighted differently for determining a probability of spatial engagement. For example, it may be determined that the user visits web pages related to sports with a first frequency, travel with a second frequency, and news with a third frequency. Accordingly, based on the first, second, and third frequency of web pages visits, it may be determined that the user likes the topics of sports, travel, and news. Such topics may be weighted according to their relative frequency. For example, if the first frequency is greater than the second and third frequencies, then it may be determined that the user has a greater interest in sports than travel and news. Accordingly, when determining spatial probability of user engagement, portions of the web page 110 that are relative to sports may be correlated with a higher probability of engagement than portions of the web page 110 related to other topics.

According to some examples, a user profile may store the user likes and/or dislikes. The user profile may store other information for the user, such as a user identifier, demographic information, content engagements or interactions, etc. According to some examples, user likes or dislikes may be inferred based on other information in the user's profile. For example, if a first user and a second user have similar profiles, a level of engagement with particular subject matter by the second user may be used to infer that the first user is also likely to engage with such subject matter. Where user profile data is inferred from other user data, such inferred profile data may be used to determine the spatial probability map 250. Using such inferred data may reduce the computing resources needed to obtain the user profile data. With respect to user profile data, the user may be provided with controls allowing the user to make an election as to what types of user information (e.g., information about a user's social network, social actions, or activities, profession, a user's preferences, or a user's current location) may be included. In addition, certain data may be treated in one or more ways before it is stored or used. Thus, the user may have control over what information is collected about the user, how that information is used, and what information is provided to the user.

Identifying the portions of the web page 110 that are relevant to particular topics may include a search for text or images related to such topics. For example, image recognition and/or character recognition techniques may be used to identify topics in the web page 110. Images or words recognized by the techniques may be compared with images or words stored in association with the topic in a database. When recognized images/words match the stored images/words to a sufficient degree, the recognized images/words may be identified as being in the topic associated with the stored images/words. For example, if a given region of the web page 110 includes words such as “score,” “defeat.” and “hustle” the given region may be identified as relating to the topic of sports. If it was determined that the user likes sports, the given region may be estimated to have a higher probability of user engagement.

The indicators 251-254 in the example of FIG. 2 are illustrated as a type of heat map, where a center of the indicators 251-254 corresponds to a portion of the web page having a highest probability of engagement. In other examples, other forms of indicators may be used. For example, the indicators may be any of a variety of sizes, shapes, colors, etc.

According to some examples, a joint probability map may be created using the user inputs, as described above in connection with FIG. 1, as well as content on the web page, as described above in connection with FIG. 2. For example, a joint probability distribution can be calculated based on all possible probability map generations. In that regard, each different content framework may have an associated joint probability distribution. For example, a first joint probability distribution may be generated for a web article, a second joint probability distribution for a video, a third joint probability distribution for music streaming, etc.

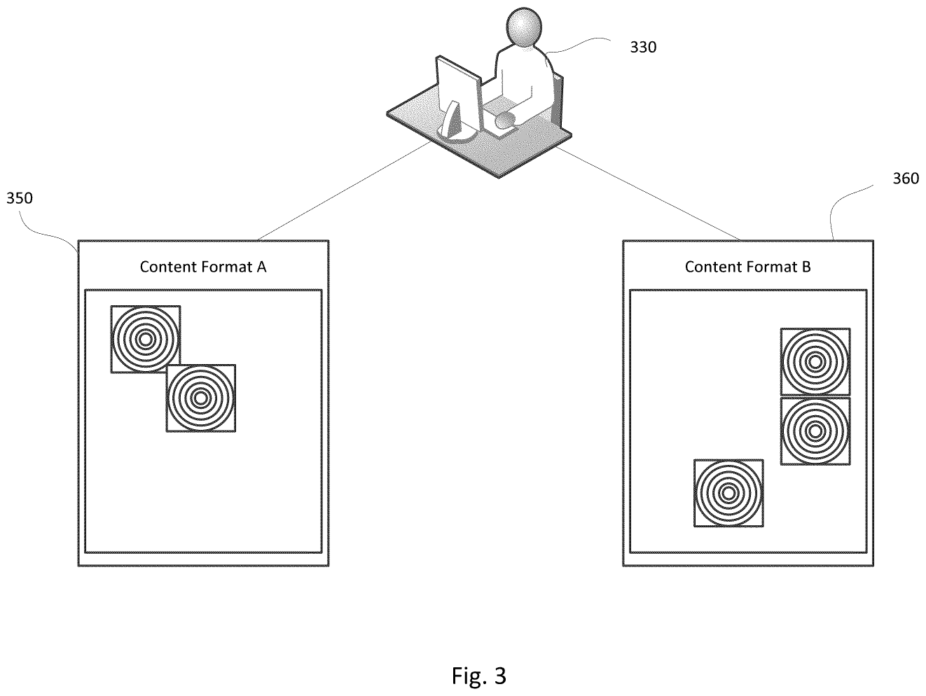

FIG. 3 illustrates an example where different probability maps are generated for different content formats for a given user 330. As shown, a first spatial probability map 350 is generated for a first content format and a second spatial probability map 360 is generated for a second content format. The first and second content formats may be different. For example, the first content format may be a web article while the second content format may be a video streaming site or application.

While two different spatial probability maps for two different content formats are shown in FIG. 3, it should be understood that any number of spatial probability maps may be generated. For example, spatial probability maps may be generated for additional content formats. In other examples, spatial probability maps may be generated for different types of content in different content formats. For example individual spatial probability maps may be generated for a web article about sports and for videos about sports.

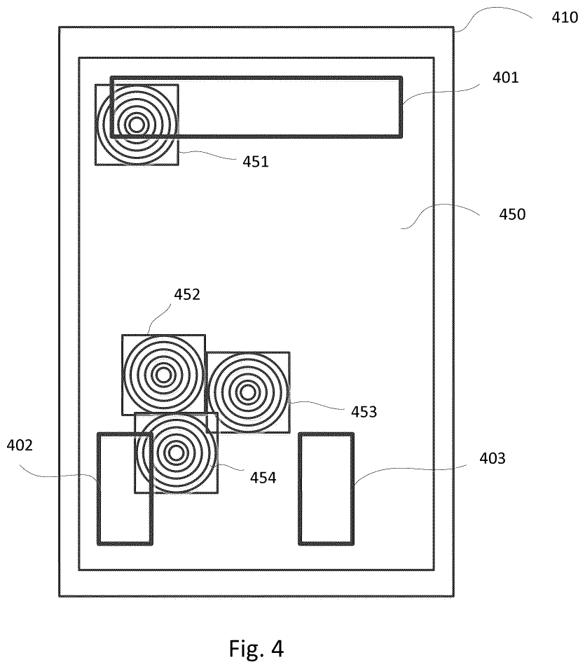

In FIG. 4, a spatial probability map 450 is combined with known banner placement options 401, 402, 403. Placement options 401, 402, 403 may be areas on the web page 410 where banners can be positioned. For example, the web page 410 or content displayed on the web page 410 may include constraints restricting areas where banners can be positioned. As an example, a web article may include constraints that banners can be placed at a top, sides, or bottom, but cannot be placed in a middle of the article. In this regard, where the banners include advertisements, such advertisements would not be disruptive to a user's enjoyment of the content.

Combining the banner placement options 401, 402, 403 with the spatial probability map 450 facilitates identification of areas where a high probability of spatial engagement overlap with the banner placement options 401, 402, 403. For example, the spatial probability map 450 includes indicators 451, 452, 453, 454 that correspond to portions of the web page 410 having a highest probability of spatial engagement by a user. Combining the banner placement options 401, 402, 403 with the spatial probability map 450 may be performed by, for example, multiplying the spatial probability map 450 with the banner placement options. Using maximum a posteriori (MAP) statistical estimation, a maximum probability may be computed for probability values trapped in each placement option 401, 402, 403. The banner placement options 401, 402, 403 can be ranked based on the computed MAP probability. In the example shown, a greatest amount of overlap between the placement options 401, 402, 403 and the indicators 451-454 occurs between placement option 401 and indicator 451. Accordingly, placement option 401 may be determined to be the best option for banner placement as it includes a highest probability of user engagement. A next greatest amount of overlap occurs between placement option 402 and indicator 454. Accordingly, placement option 402 may be determined to be a next best placement option, as it includes a second highest probability of user engagement. In this regard, advertisements or other information to be placed in the banner regions can be prioritized. A highest priority banner can be placed in a region having the highest MAP probability, a next highest priority banner can be placed in a region having a second highest MAP probability, and so on. Following the example above, a highest priority advertisement can be placed in banner placement option 401 that included a highest degree of overlap with the probability indicators 451-454, and a next highest priority advertisement can be placed in banner placement option 402 that included a next highest degree of overlap.

Banner placement options having insufficient probability of engagement based on the spatial engagement map 450 may be excluded from use in displaying banners with content on the web page 410. For example, banner placement option 403 does not overlap with any indicators 451-454, thereby indicating a low probability that the user would engage with a banner placed at the banner placement option 403. Accordingly, banners may be omitted from the placement option 403. In this regard, the content and banners in placement options 401, 402 can be transmitted to a user device and rendered more efficiently, as the bandwidth, power, and other resources are not used for transmitting and rendering a banner in placement option 403.

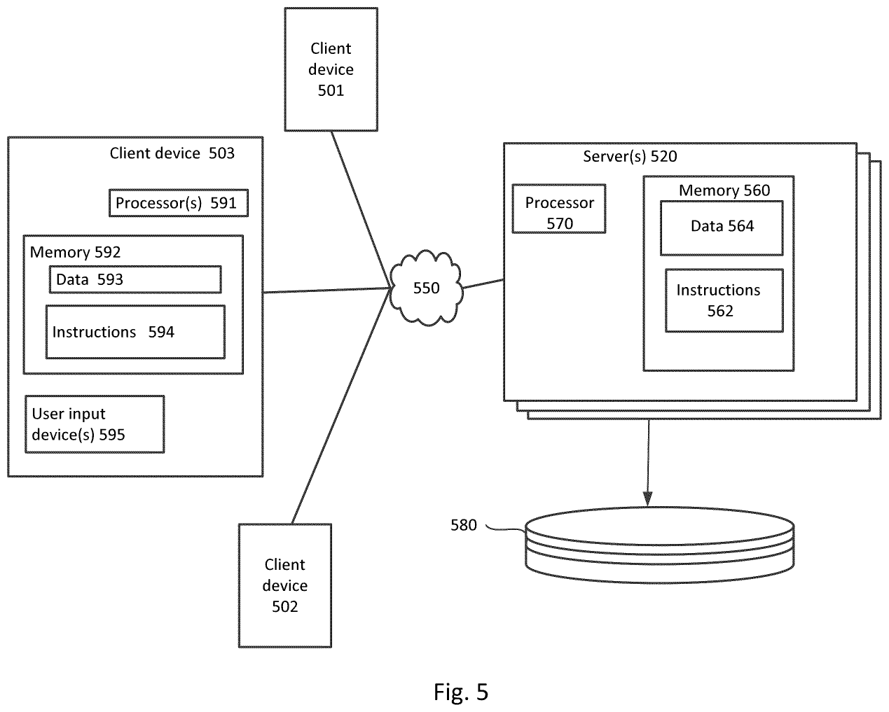

FIG. 5 illustrates an example system for determining personalized banner placement. In particular, the system includes one or more client devices 501, 502, 503 in communication with one or more servers 520 through a network 550. For example, each of a number of different client devices 501-503 may receive content, such as articles, images, videos, music, etc., from the server 520. Based on a type of the content, format of the content, and/or user that will receive the content, banners accompanying the content will have a particular arrangement on the web page. Such arrangement may vary the position, size, shape, and/or number of banners from one client device to the next, thereby rendering a personalized content and banner display. The arrangement may omit banners from possible placement options where a probability of spatial engagement would be low, thereby conserving resources such as bandwidth, power, etc. that would otherwise be required to transmit and display the omitted banners. While several client devices 501-503 are shown, it should be understood that any number of client devices may communicate with the one or more servers 520 through the network 550.

The server 520 includes one or more processors 570. The processors 570 can be any conventional processors, such as commercially available CPUs. Alternatively, the processors can be dedicated components such as an application specific integrated circuit (“ASIC”) or other hardware-based processor. Although not necessary, the server 520 may include specialized hardware components to perform specific computing processes.

The memory 560 can store information accessible by the processor 570, including instructions that can be executed by the processor 570 and that can be retrieved, manipulated or stored by the processor 570.

The instructions can be a set of instructions executed directly, such as machine code, or indirectly, such as scripts, by the processor 570. In this regard, the terms “instructions,” “steps” and “programs” can be used interchangeably herein. The instructions can be stored in object code format for direct processing by the processor 570, or other types of computer language including scripts or collections of independent source code modules that are interpreted on demand or compiled in advance. Functions, methods, and routines of the instructions are explained in more detail in the foregoing examples and the example methods below.

The data can be retrieved, stored or modified by the processor 570 in accordance with the instructions. The data can also be formatted in a computer-readable format such as, but not limited to, binary values, ASCII or Unicode. Moreover, the data can include information sufficient to identify relevant information, such as numbers, descriptive text, proprietary codes, pointers, references to data stored in other memories, including other network locations, or information that is used by a function to calculate relevant data.

Although FIG. 5 functionally illustrates the processor, memory, and other elements of server 520 as being within the same block, the processor, computer, computing device, or memory can actually comprise multiple processors, computers, computing devices, or memories that may or may not be stored within the same physical housing. For example, the memory can be a hard drive or other storage media located in housings different from that of the server 520. Accordingly, references to a processor, computer, computing device, or memory will be understood to include references to a collection of processors, computers, computing devices, or memories that may or may not operate in parallel. For example, the server 520 may include server computing devices operating as a load-balanced server farm, distributed system, etc. Yet further, although some functions described below are indicated as taking place on a single computing device having a single processor, various aspects of the subject matter described herein can be implemented by a plurality of computing devices, for example, communicating information over a network.

The memory 560 can store information accessible by the processor 570, including instructions 562 that can be executed by the processor 570. Memory can also include data 564 that can be retrieved, manipulated or stored by the processor 570. The memory 560 may be a type of non-transitory computer readable medium capable of storing information accessible by the processor 570, such as a hard-drive, solid state drive, tape drive, optical storage, memory card, ROM, RAM, DVD, CD-ROM, write-capable, and read-only memories. The processor 570 can be a well-known processor or other lesser-known types of processors. Alternatively, the processor 570 can be a dedicated controller such as an ASIC.

The instructions 562 can be a set of instructions executed directly, such as machine code, or indirectly, such as scripts, by the processor 570. In this regard, the terms “instructions,” “steps” and “programs” can be used interchangeably herein. The instructions 562 can be stored in object code format for direct processing by the processor 570, or other types of computer language including scripts or collections of independent source code modules that are interpreted on demand or compiled in advance.

The data 564 can be retrieved, stored or modified by the processor 570 in accordance with the instructions 562. For instance, although the system and method is not limited by a particular data structure, the data 564 can be stored in computer registers, in a relational database as a table having a plurality of different fields and records, or XML documents. The data 564 can also be formatted in a computer-readable format such as, but not limited to, binary values, ASCII or Unicode. Moreover, the data 564 can include information sufficient to identify relevant information, such as numbers, descriptive text, proprietary codes, pointers, references to data stored in other memories, including other network locations, or information that is used by a function to calculate relevant data.

The instructions 562 may be executed to compute an optimized banner placement for a given user, wherein the banner placement for that user can vary based on a type of content. The type of content may relate to the subject matter presented therein, such as sports, travel, news, music, research/academics, etc. The banners can include, for example, advertisements, notifications, or other information for the user. The optimization of the banner placement is based on a spatial probability of engagement by the given user. For example, the instructions 562 may be executed to generate a spatial probability map, which is used in conjunction with banner placement options or other constraints to determine a placement for the banner having a highest probability of user engagement.

The servers 520 may be further coupled to an external storage 580, such as a database. The external storage 580 may store content for delivery to the client devices 501-503. The external storage 580 may further store banners for rendering at the client devices 501-503 along with the content. Such banners may include advertisements or other information. While the external storage 580 is shown as a single database, it should be understood that the physical structure of the external storage 580 can include multiple storage devices, wherein such multiple devices may be in communication with each other such as in a distributed storage system.

Each client device 501, 502, 503 may be configured similarly to one another and to the servers 520 in that they include a processor 591 and memory 592 including data 593 and instructions 594 executable by the processor 591. The structure of the processor 591 and memory 592 may be similar to that of the processor 570 and memory 560, respectively, described above. The client devices 501-503 may be any type of personal computing devices, such as laptops, desktop computers, tablets, gaming consoles, phones, augmented reality or virtual reality headsets, smartwatches, smartglasses, home assistant hubs, or any other computing device including a display for outputting content along with one or more banners.

Each client device 501-503 may further include one or more user input devices 595. Such user input devices 595 may include touchscreens, touchpads, keypads, cameras, microphones, joysticks, or any other device adapted to capture input signals from a user. The user input devices 595 may capture user input signals indicating user interests, actions, etc. For example, the user input devices 595 may be utilized by the user in scrolling through content, such as by swiping a touchscreen, clicking and dragging with a mouse, rolling a trackball, etc. A speed of such scrolling may be used to determine a duration of time for which the user views each of a number of regions of a web page. Such duration of time may be used to determine a spatial probability of engagement for each region of the web page, which may be used to determine the optimized banner placement. In other examples, the user input devices 595 may be utilized in the user's web activity, such as browsing web pages, clicking on web links, etc. User profile data may be populated based on such activity, the user profile data indicating the user's interests. Such interests may be used to determine a spatial probability of engagement for a web page, such as my using a language-vision model for the web page that recognizes text or images that correspond to the user profile data.

Further to the example systems described above, example methods are now described. Such methods may be performed using the systems described above, modifications thereof, or any of a variety of systems having different configurations. It should be understood that the operations involved in the following methods need not be performed in the precise order described. Rather, various operations may be handled in a different order or simultaneously, and operations may be added or omitted.

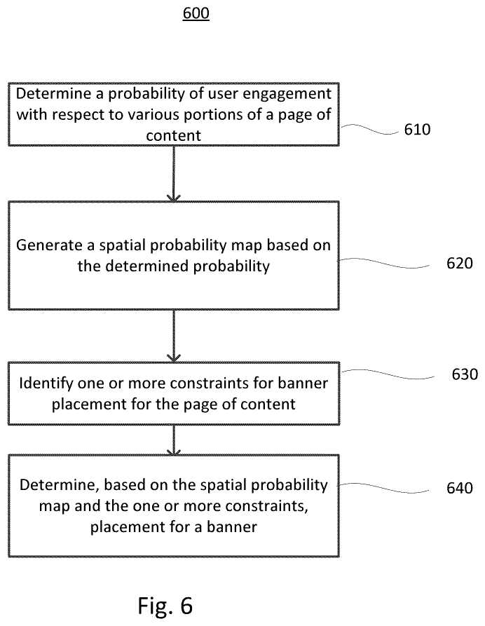

FIG. 6 illustrates an example method 600 for determining a spatial engagement probability map for a given user, and determining optimal banner placement based on the spatial engagement probability map. The method may be performed by, for example, a computing device or module, or a system of one or more distributed server processes.

In block 610, a probability of user engagement with respect to various portions of a page of content is determined. The probability of engagement may be determined based on one or more of user inputs, topics or subject matter in the content, or other information. The user inputs may include for example, scrolling speed of the user, eye gaze, context of the web page, etc. The context of the web page may identify how the web page is presented, which can inform a probability that the user is looking at the web page or is distracted. Examples of context include how many browser tabs are open, when the web page is a main tab or a background tab, etc. Topics or subject matter in the content may be compared to topics or subject matter that is known or inferred as being of interest to the user. For example, keywords or images in the content may be compared to information stored in a user profile indicating the user's interests. The user profile may be populated based on express or implicit user input, and/or inferences from other user's having similar interests.

In block 620, a spatial probability map is generated based on the determined probability of user engagement. The map may be one-dimensional, two-dimensional, etc. The map may be generated such that regions of the web page having greater view time, such as detected by scrolling speed or eye gaze, are mapped to a higher probability of user engagement. In other examples, the map may be generated such that a position of detected keywords or images on the web page that match the user's interests is marked with an indicator of a higher probability of user engagement. While these are a few examples of how spatial probability maps are generated, other examples are also possible. By way of example, the map may be generated based on movement of a cursor, which correlates with attention.

In block 630, one or more constraints are identified for banner placement for the page of content. The constraints may be restrictions on where banners can be placed on the web page. For example, banner placement options may be limited to areas at a top, bottom, or sides of the web page to avoid disruption of the content. Other constraints may relate to a duration of time for which banners can be displayed, a size and/or shape of the banners, etc. According to some examples, identification of constraints may include generating a placement options map that identifies areas of the web page where banners are permitted.

In block 640, the spatial probability map and the one or more constraints are used to determine placement for one or more banners. For example, the spatial probability map and constraints may be combined, such that areas of the web page having a high probability of user engagement can be correlated with areas in which banner placement is permitted. In this regard, banner placement options can be ranked based on which areas that are options for banner placement have a highest probability of user engagement. Moreover, banners can be prioritized based on the rank. For example, advertisements having a highest value or priority can be placed in the highest ranking option. Additionally, while some areas may be identified as banner placement options, banners may be omitted from those areas. For example, if such areas are determined to have a low probability of user engagement, banners can be omitted from those areas. In that regard, computing resources such as bandwidth and power can be conserved that would otherwise be consumed in transmitting banners to a client device for rendering in those low probability areas.

According to some examples, the web page can be dynamically updated with respect to banner placement. For example, as the user's scrolling speed is detected, optimal banner placement can be determined based on such scrolling speed in near real-time, such that banners are placed in regions that will soon come within a field of view as the user continues scrolling. According to other examples, the scrolling speed for a given piece of content may be used to inform banner placement for similar content formats and/or content topics rendered on subsequent web pages.

While the examples described above refer to generating a spatial probability map and determining banner placement in connection with a web page, the techniques described above may similarly be applied for other mediums through which content is provided, such as mobile applications or the like.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of determining banner placement, comprising:
determining, with one or more processors, a probability of user engagement with respect to various portions of a page of content;
generating, with the one or more processors, a spatial probability map based on the determined probability, the spatial probability map indicating user engagement probability with respect to the various portions of the page of content;
identifying, with the one or more processors, one or more constraints for banner placement for the page of content;
determining, based on the spatial probability map in combination with the one or more constraints, placement for at least one banner; and
transmitting, by the one or more processors, the at least one banner to a user device for rendering in the determined placement.

2. The method of claim 1, wherein determining the probability of user engagement comprises detecting user input signals in relation to the page of content.

3. The method of claim 2, wherein the user input signals comprise at least one of frequency or speed of scrolling.

4. The method of claim 3, wherein the user input signals further comprise information related to visibility of the page with respect to other browser tabs.

5. The method of claim 1, wherein determining the probability of user engagement comprises:
identifying a topic of the content;
determining, with the one or more processors, a user preference weight for the topic of the content; and
determining the probability of user engagement based on the user preference weight for the topic of the content.

6. The method of claim 5, wherein identifying the topic of the content is based on identification of keywords.

7. The method of claim 5, wherein determining the user preference weight for the topic of content is based on historical user interaction with the topic of the content among a variety of other topics of content.

8. The method of claim 5, wherein determining the user preference weight for the topic of content is based on historical user interaction with the topic of the content from a plurality of users.

9. The method of claim 1, further comprising receiving digital content and the at least one banner at the user device, and rendering the digital content with the at least one banner in the determined placement for the banner.

10. The method of claim 1, further comprising preventing rendering of at least one second banner in at least one second banner location in the page of content.

11. The method of claim 1, wherein the one or more constraints comprise options for banner placement based on a degree of interference with the content.

12. The method of claim 11, wherein determining placement for the banner comprises:
determining, with the one or more processors, a degree of overlap between the spatial probability map and the options for banner placement; and
identifying, with the one or more processors, portions of the page having a highest degree of overlap.

13. A system for determining banner placement, comprising:
memory; and
one or more processors in communication with the memory, the one or more processors configured to:
determine a probability of user engagement with respect to various portions of a page of content;
generate a spatial probability map based on the determined probability, the spatial probability map indicating user engagement probability with respect to the various portions of the page of content;
identify one or more constraints for banner placement for the page of content;
determine, based on the spatial probability map in combination with the one or more constraints, placement for at least one banner; and
transmit the at least one banner to a user device for rendering in the determined placement.

14. The system of claim 13, wherein in determining the probability of user engagement the one or more processors are further configured to detect user input signals in relation to the page of content.

15. The system of claim 14, wherein the user input signals comprise at least one of frequency or speed of scrolling.

16. The system of claim 15, wherein the user input signals further comprise information related to visibility of the page with respect to other browser tabs.

17. The system of claim 13, wherein in determining the probability of user engagement the one or more processors are further configured to:
identify a topic of the content;
determine a user preference weight for the topic of the content; and
determine the probability of user engagement based on the user preference weight for the topic of the content.

18. The system of claim 17, wherein identifying the topic of the content is based on identification of keywords.

19. The system of claim 17, wherein the user preference weight for the topic of content is based on historical user interaction with the topic of the content among a variety of other topics of content.

20. The system of claim 17, wherein the user preference weight for the topic of content is based on historical user interaction with the topic of the content from a plurality of users.

21. The system of claim 13, wherein the one or more processors are further configured to transmit digital content and at least one banner to a client device for rendering the digital content along with the at least one banner in the determined placement for the banner.

22. The system of claim 21, further comprising preventing rendering at least one second banner in at least one second banner location in the page of content.

23. The system of claim 13, wherein the one or more constraints comprise options for banner placement based on a degree of interference with the content.

24. The system of claim 23, wherein in determining placement for the banner the one or more processors are further configured to:
determine a degree of overlap between the spatial probability map and the options for banner placement; and
identify portions of the page having a highest degree of overlap.

25. A non-transitory computer-readable medium storing instructions executable by one or more processors for performing a method of determining banner placement, comprising:
determining a probability of user engagement with respect to various portions of a page of content;
generating a spatial probability map based on the determined probability, the spatial probability map indicating user engagement probability with respect to the various portions of the page of content;
identifying one or more constraints for banner placement for the page of content;
determining, based on the spatial probability map in combination with the one or more constraints, placement for at least one banner; and
transmitting the at least one banner to a user device for rendering in the determined placement.
